(19) United States
(12) Patent Application Publication
(10) Pub. No.: US 2020/0375357 A1
(43) Pub. Date: Dec. 3, 2020

(54) FURNITURE HAVING A CONCEALED LOCKABLE COMPARTMENT

(71) Applicant: Ming CHIANG, Amityville, NY (US)

(72) Inventor: Ming CHIANG, Amityville, NY (US)

(21) Appl. No.: 16/425,245

(22) Filed: May 29, 2019

(51) Int. Cl. A47B 83/04; A47B 88/40; E05C 19/16; E05B 47/00; E05B 15/02

(52) U.S. Cl. CPC A47B 83/045; A47B 88/40; E05Y 2900/20; E05B 47/004; E05B 15/0205; E05C 19/16

(57) ABSTRACT

Furniture with a concealed compartment is provided. The furniture includes a tabletop and a base. Tracks on sides of the base mate with interior channels of the tabletop to enable the tabletop to be slid to reveal or conceal the compartment. The compartment may include a locking mechanism that prevents access to the compartment. The locking mechanism can be unlocked using a magnet.

### BACKGROUND OF THE INVENTION

### 1. Technical Field

The present disclosure relates to the field of furniture, and more particularly to furniture having a concealed lockable compartment.

### 2. Discussion of Related Art

Furniture refers to movable objects intended to support various human activities such as seating (e.g., chairs), eating (e.g., tables), sleeping (e.g., beds), and storing objects (e.g., a chest of drawers).

A chest of drawers, also called a bureau, is a type of cabinet that has multiple parallel, horizontal drawers usually stacked one above another. An end or side table includes at least one drawer and a table top. Since these drawers are designed to freely open and close, they are not well suited for protecting valuables or safeguarding firearms. Thus, lockable drawer compartments have been developed to protect valuables and to safeguard firearms.

A lockable drawer compartment includes a lock with a keyhole that prevents the drawer from being opened until the proper key is placed in the keyhole and used to unlock the lock. However, since the lock and keyhole are visible, a thief can quickly surmise the location of items being protected or safeguarded. Further, if the owner loses the key, he may need to damage the furniture or hire an expensive locksmith in order to regain access to his items.

Thus, there is a need for an article of furniture with a lockable compartment that is both concealed and openable without a standard key.

### SUMMARY OF THE INVENTION

According to an exemplary embodiment of the inventive concept, furniture with a concealed compartment is provided. The furniture includes a tabletop and a base. Tracks on sides of the base mate with interior channels of the tabletop to enable the tabletop to be slid to reveal or conceal the compartment. The compartment may include a locking mechanism that prevents access to the compartment. The locking mechanism can be unlocked using a magnet.

According to an exemplary embodiment of the inventive concept, an article of furniture is provided including a tabletop and a base. The tabletop includes a first horizontal side, a first vertical side including a first channel, a second vertical side including a second channel and opposing the first vertical side, and a third vertical side opposing an open side. The first through third vertical sides are affixed to a bottom of the first horizontal side. The base includes a fourth vertical side including a first track, a fifth vertical side including a second track opposing the fourth vertical side, and a second horizontal side affixed to the fourth and fifth vertical sides to form sides of a compartment on top of the base. The channels are configured to mate with the tracks to enable the tabletop to be slid to reveal or conceal the compartment. The article of furniture may further include a locking mechanism located within the compartment that prevents the tabletop from being removed from the base. In an exemplary embodiment, the locking mechanism includes a magnetic pin affixed to a bottom of the first horizontal side and configured to move in a vertical direction, and a bracket having a through-hole, where the bracket is affixed to a side of the compartment, and the magnetic pin is configured to engage with the through-hole. The magnetic pin may be configured to move in the vertical direction towards a top of the tabletop to disengage with the through-hole when a magnet is placed on the tabletop. The bracket may further include a ramp portion that guides the magnetic pin into the through-hole. In an exemplary embodiment, the through-hole is a first distance away from the vertical side the bracket is affixed to, the magnetic pin is a second distance away from one of the vertical sides of the base, and the distances are configured so that the through-hole and the magnetic pin are aligned with one another when the tabletop is mated with the base. In an exemplary embodiment, the locking mechanism further includes a flanged sleeve disposed in a recess in the bottom of the first horizontal side, and the magnetic pin is located within a through-hole of the flanged sleeve. In an embodiment, the magnetic pin includes a cylinder and an annulus surrounding the cylinder that prevents the magnetic pin from entirely exiting through an opening of the flanged sleeve. Each of the channels may include a drawer slide that is configured to mate with one of the tracks. In an embodiment, the base further includes a sixth vertical side and a seventh vertical side opposing the sixth vertical side to form other sides of the compartment. A depth of the compartment may be less than a height of the sides of the base. In an embodiment, the compartment has a cuboid shape. The base may include a removable drawer below the compartment. In an embodiment, the tabletop and the base combine to form an end table.

According to an exemplary embodiment of the inventive concept, an article of furniture is provided including a tabletop, a base, and a bracket. The tabletop includes a movable magnetic pin affixed to a bottom surface of the tabletop and channels on sides protruding from the bottom surface. The base includes a first vertical side including a first track, a second vertical side including a second track opposing the first vertical side, and a horizontal side affixed to the first and second vertical sides to form sides of a compartment on top of the base. The bracket includes a through-hole and the bracket is affixed to a side of the compartment. The channels are configured to mate with the tracks and the magnetic pin is configured to engage with the through-hole. In an embodiment, the magnetic pin is configured to move towards a top of the tabletop to disengage with the through-hole when a magnet is placed on the tabletop. In an embodiment, the bracket further includes a ramp portion that guides the magnetic pin into the through-hole. An end of the ramp portion may be lower than the through-hole. The though-hole and the pin may be aligned with one another when the channels are mated with the tracks. The article of furniture may further include a flanged sleeve disposed in a recess in the bottom of the tabletop where the magnetic pin is located within a through-hole of the flanged sleeve.

Additional features and advantages of the above embodiments and additional embodiments of the present disclosure are outlined in the description which follows, and in part will be obvious from the description, or may be learned by the practice of such example embodiments.

### BRIEF DESCRIPTION OF THE DRAWINGS

Exemplary embodiments of the invention can be understood in more detail from the following descriptions taken in conjunction with the accompanying drawings in which:

FIG. 1 illustrates furniture with a concealed compartment according to an exemplary embodiment of the present inventive concept; and

FIG. 2 illustrates a side view of an upper portion of a base of the furniture illustrated in FIG. 1 according to an exemplary embodiment of the present inventive concept;

FIG. 3 illustrates an overhead view of the upper portion of FIG. 2 according to an exemplary embodiment of the present inventive concept;

FIG. 4 illustrates a blown-up view of a part of FIG. 3 according to an exemplary embodiment of the present inventive concept;

FIG. 5 illustrates a side view of a portion of FIG. 4 according to an exemplary embodiment of the present inventive concept;

FIG. 6 illustrates a top down view of an underside of a tabletop of FIG. 1 according to an exemplary embodiment of the present inventive concept;

FIG. 7 illustrates a side view of a blown-up portion of FIG. 5 according to an exemplary embodiment of the inventive concept;

FIG. 8 illustrated a method of using the furniture to reveal the compartment according to an exemplary embodiment of the present inventive concept; and

FIG. 9 illustrates a method of manufacturing a locking mechanism of the furniture according to an exemplary embodiment of the present inventive concept.

### DETAILED DESCRIPTION OF THE EXEMPLARY EMBODIMENTS

One or more embodiments of the present disclosure provide furniture with a concealed compartment. The furniture includes a tabletop and a base. Tracks on sides of the base mate with interior channels of the tabletop to enable the tabletop to be slid until the compartment is revealed or concealed. The compartment may include a locking mechanism that prevents access to the compartment. The locking mechanism can be unlocked using a magnet. Since the locking mechanism is not visible when the tabletop is in place, a thief is not able to surmise that valuables are secured within the furniture. Further, in embodiments of the invention where the locking mechanism is present, since the locking mechanism can be opened with a magnet, a standard key is not necessary.

Additional detail will now be provided regarding the furniture in relation to illustrative figures portraying exemplary embodiments.

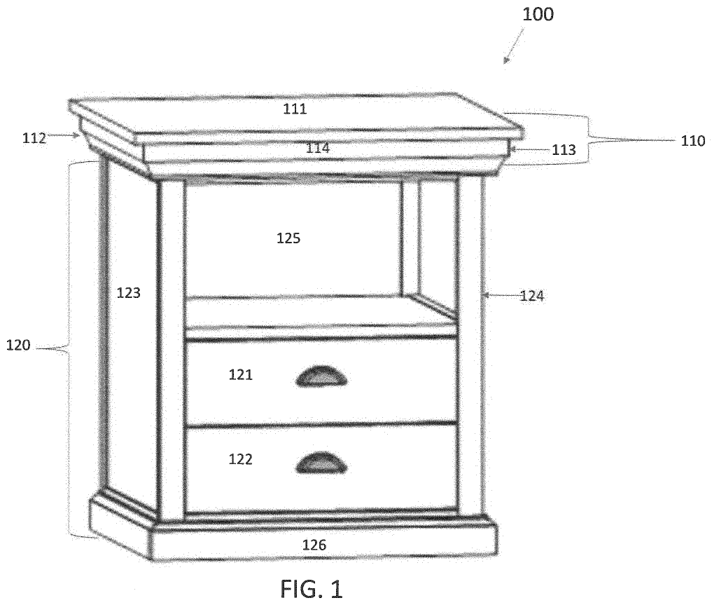

In particular, FIG. 1 illustrates an exemplary embodiment of the furniture 100 when implemented as an end table including a table top 110 and a base 120. While the end table in FIG. 1 is depicted as having two drawers 121 and 122, the inventive concept is not limited thereto. For example, there may be additional drawers, only one drawer, or no drawers. While the inventive concept will be discussed below using this end table implementation, embodiments of the inventive concept are not limited to this implementation. For example, the furniture 100 could be implemented instead as a chest of drawers of various configurations or a table without any drawers. For example, the base 100 could be replaced with an upper portion housing the compartment and one or more legs to support the upper portion.

The tabletop 110 includes a top side 111 (e.g., a horizontal side), a first side 112 opposing a second side 113 and a third side 114. The shape of the second side 113 may be symmetrical to the first side 112. While FIG. 1 illustrates the sides 112-114 each including vertical and sloped sides, the inventive concept is not limited thereto. For example, the sides 112-114 may only include the vertical sides, and thus side 114 may be perpendicular to sides 112 and 113.

The base 120 includes opposing sides 123 and 124. The sides 123 and 124 may be arranged in a vertical direction. The base 120 may include a back side 125 and a bottom portion 126.

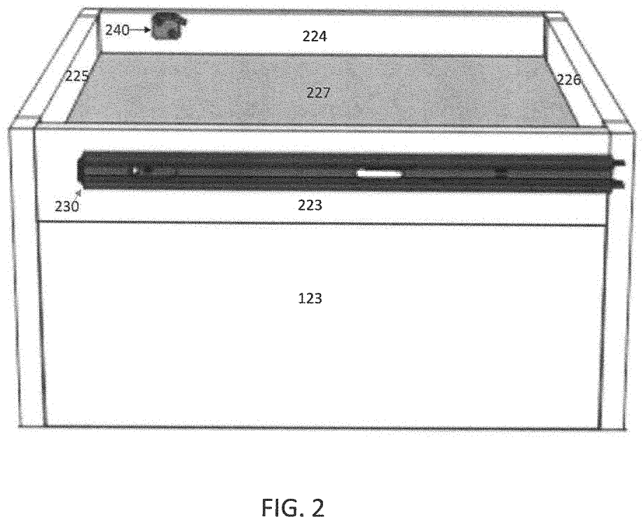

Although not visible in FIG. 1, the tabletop 110 includes a hollow area or a recess so it can mate with a concealed compartment in an upper portion of the base 120. Further, this hollow area may include portions of a locking mechanism to prevent the tabletop 110 from being removed to expose the concealed compartment. When the locking mechanism is unlocked, the tabletop 110 can be entirely removed by pulling the tabletop 110 in a forward direction. For example, the forward direction may be the same direction in which a drawer (e.g., 121) is pulled to open the drawer. The upper portion of the base 120 is not visible in FIG. 1, since it is concealed by the tabletop 110. The upper portion will be discussed in more detail with respect to FIG. 2.

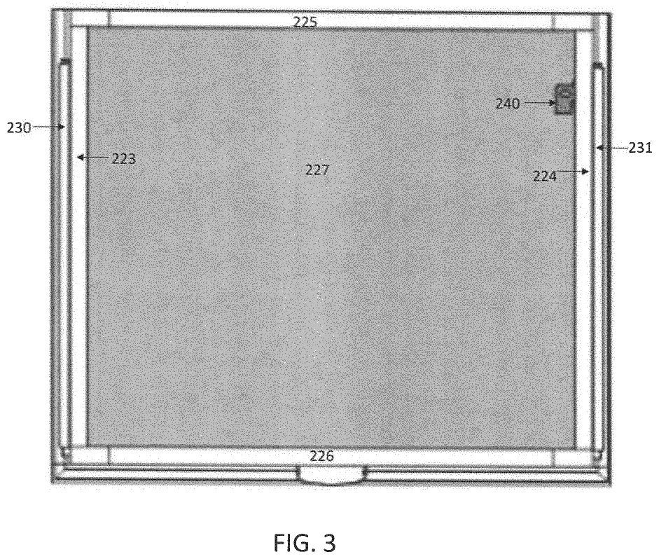

FIG. 2 illustrates a side view of the upper portion of the base 120 once the tabletop 110 has been completely removed, and FIG. 3 illustrates an overhead view of the upper portion. As shown in FIGS. 2-3, the upper portion includes opposing sides 223 and 224, opposing sides 225 and 226, and a bottom side 227 that together form a compartment that is concealed from view when the tabletop 110 is restored. Side 225 may be perpendicular to sides 223 and 224 and side 226 may be perpendicular to sides 223 and 224. In an embodiment, the depth of the compartment is less than a height of all or one of sides 223, 224, 225, or 226. The bottom side 227 may include an upholstered surface to prevent scratching of the compartment by items placed therein. A first track 230 is affixed to an outer surface of side 223 and a second track 231 is affixed to an outer surface of opposing side 224. In an embodiment, the tracks 230 and 231 are configured to mate with internal channels on sides 112 and 113 of the tabletop 110. In a further embodiment, the tracks 230 and 231 are configured to mate with retractable drawer slides within those channels. The upper portion 223 further includes a bracket 240, which is part of the locking mechanism.

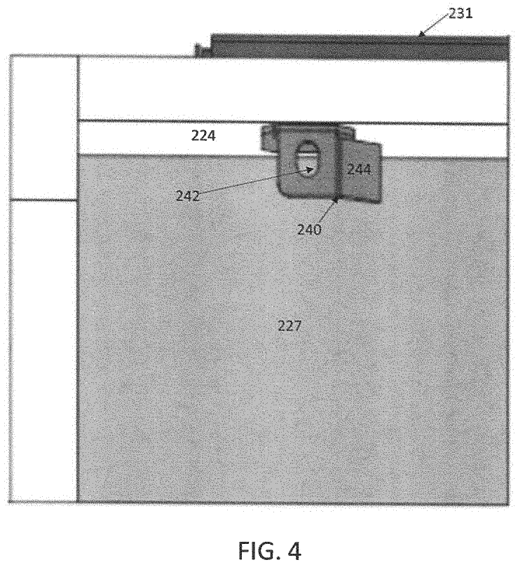

FIG. 4 illustrates a blown-up view of a part of FIG. 3 so that the bracket 240 is more clearly visible. As shown in FIG. 4, the bracket 240 is affixed to an inner surface of side 224. However, embodiments of the inventive concept are not limited thereto. For example, the bracket 240 may be affixed to an inner surface of side 225 or side 223. As shown in FIG. 4, the bracket 240 includes a through-hole 242 and a ramp portion 244 (or a ramp). The bracket 240 may be made of a metal but is not limited thereto. The ramp portion 244 is optional. The ramp portion 244, when present, is slanted downward from an edge of the bracket 240 near the through-hole 242 towards the bottom side 227 of the compartment. In an exemplary embodiment, the ramp portion 244 is angled at an acute angle with respect to the edge. In an exemplary embodiment, the ramp portion 244 does not make contact with the bottom side 227.

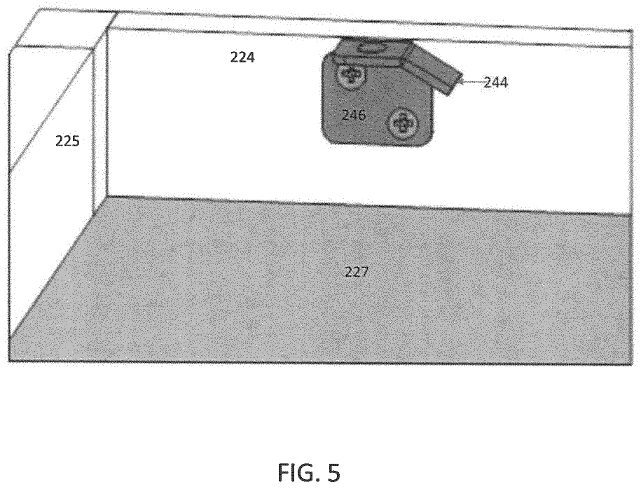

FIG. 5 illustrates a side view of a portion of FIG. 4 so that a side view of the bracket 240 can be observed. As shown in FIG. 5, the bracket 240 includes a side portion 246 (e.g., a plate) that is affixed to the outer surface of side 224. While FIG. 5 shows that the side portion 246 is affixed using a pair of screws, the inventive concept is not limited thereto. For example, the side portion 246 may be affixed using less than two screws, more than two screws, one or more nails, an adhesive. etc. Further, an alternate embodiment, the side portion 246 is omitted.

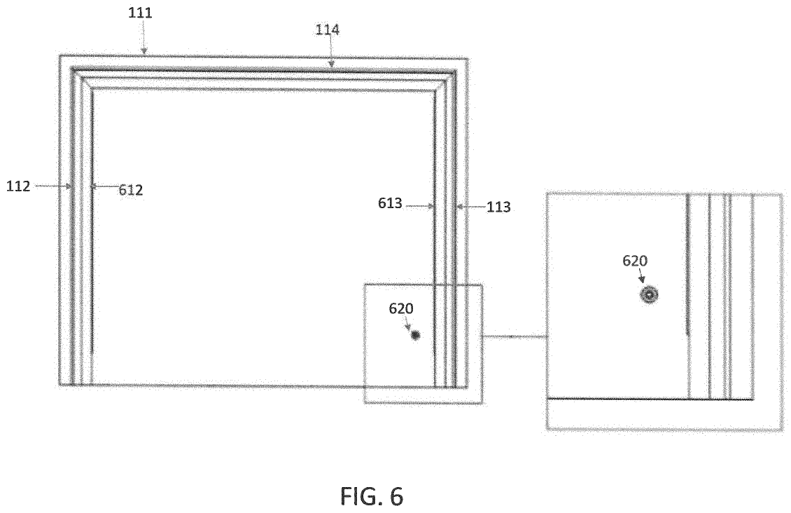

FIG. 6 illustrates a top down view of an underside of the tabletop 110 according to an exemplary embodiment of the inventive concept. The tabletop 110 includes a first drawer slide 612 located in a channel on an inner surface of side 112 and a second drawer slide 613 disposed in a channel on an inner surface of side 113. As shown in FIG. 6, the tabletop 110 includes opposing sides 112 and 113 and side 114 that opposes an open side. Each of the drawer slides 612 and 613 may extend beyond the open side. Further, the first drawer slide 612 may mate with the first track 230 and the second drawer slide 613 may mate with the second track 231 so that the tabletop 110 slides until it conceals the compartment. A pin structure 620 is located on the underside of the tabletop 110. The pin structure 620 includes a magnetic pin (e.g., an iron cylinder) that freely moves up and down into an interior recess of the tabletop 620 or into the compartment. The length of the pin and its range of motion (e.g., linear motion) is designed so that it can pass sufficiently through the through-hole 242 of the bracket 240 to prevent the tabletop 110 from being slid off to reveal the compartment. When the tabletop 110 is in place and concealing the compartment, a least a portion of the magnetic pin is located within the through-hole (i.e., in the locked position). Gravity prevents the magnetic pin from being lifted into a position that would enable a user to slide the tabletop 110 forward. The depth of the interior recess is designed to be deep enough to allow the magnetic pin to be moved entirely out of the through-hole 110 (i.e., into the unlocked position) so the user can slide the tabletop 110 forward to reveal the compartment. A magnet can be placed on the surface of the tabletop 110 over a position of the pin structure 110, thereby moving the magnetic pin upward into the interior recess into the unlocked position. Then, a user can slide the tabletop 110 towards themselves since the pin is no longer acting as an obstruction. Referring to FIG. 4, when the tabletop 110 is being slid back into place, the ramp structure 244 may aid the pin in moving into the through-hole 242. For example, the pin, hanging due to gravity, may catch on the bottom of the ramp structure 244 when the tabletop 110 is slid (pushed) backward to a position at or near the ramp structure 244, and then be moved (guided) upward along a ramp of the ramp structure 244 and into the through-hole 242 when the tabletop 110 is pushed further backward.

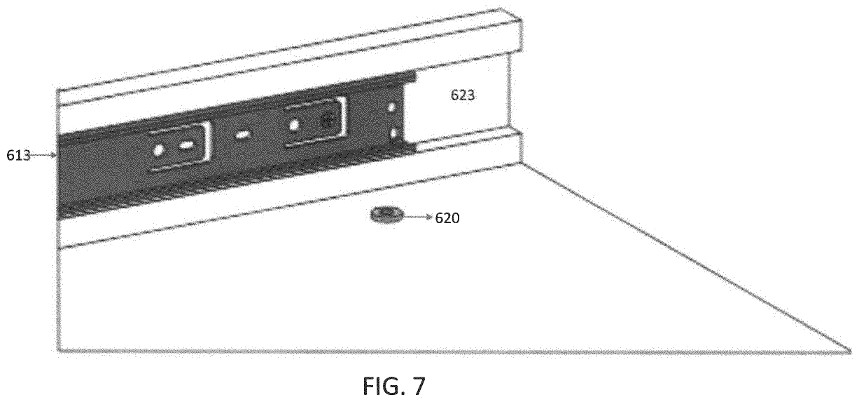

FIG. 7 illustrates a side view of a blown-up portion of FIG. 5 according to an exemplary embodiment of the inventive concept. As shown in FIGS. 6-7, the inner side of side 113 includes channel 623 and the drawer slide 613 is located within the channel 623. Although FIG. 7 does not show the opposing side 112, the opposing side 112 also includes a channel the same as channel 623, and its drawer slide 612 is similarly located in its channel. The pin structure 620 appears in FIG. 7 as an inner oval (or circle) surrounding by an outer oval (or circle) to show an example where the pin structure 620 is implemented by a flanged sleeve (i.e., the outer oval) and a magnetic cylinder or pin (i.e., the inner oval). In this figure, the pin is in an unlocked position, and accordingly, the pin has been pulled into the interior recess of the tabletop 110. The flanged sleeve may be implemented by a linear bushing, a round flange linear bushing, a linear motion bearing, etc. In an embodiment, the flanged sleeve is a hollow cylinder with opposing first and second ends of different radiuses. The radius of the first end is large enough to allow the pin to freely pass into the interior of the cylinder, but the radius of the second end is too small to allow the pin to entirely exit. The pin may be surrounded by an annulus then prevents the pin from moving completely beyond the second end.

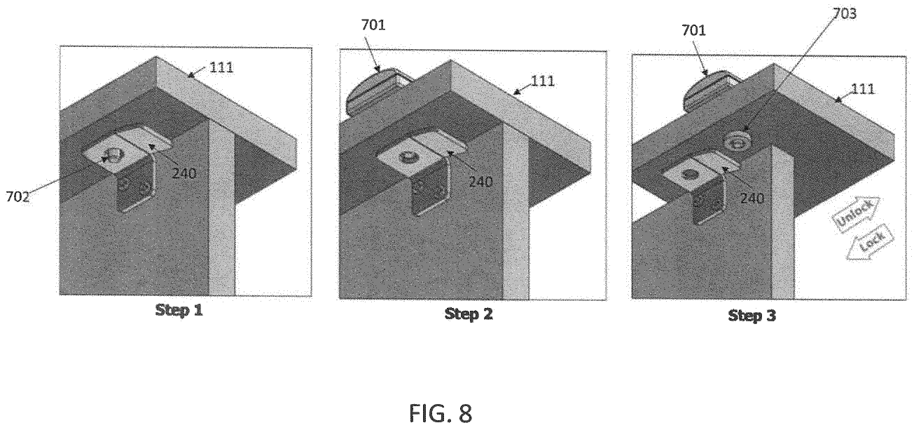

FIG. 8 illustrates a view to show step by step how the tabletop 110 is moved from a locked position to an unlocked position. In step 1 of FIG. 8, the magnet 701 is not on a top surface 111 of the tabletop 701. Thus, due to gravity, at least a portion of the pin 702 of the pin structure 620 is located in the through-hole 242 of the bracket 240. Thus, a user is not able to pull the tabletop 110 toward themselves to reveal the compartment. Then, in step 2 of FIG. 8, a magnet 701 is placed on the top surface 111 over the pin 702, thereby causing the pin 702 to move upward into an internal recess of the tabletop 110 and out of the through-hole 242. Then, in step 3 of the FIG. 8, the user has pulled the tabletop 110 toward themselves past the bracket 240 to reveal a part of the compartment. The user can then continue pulling the tabletop 110 to reveal the remainder of the compartment. If the user pulls the tabletop 110 too far, the drawer slides 612/613 may become disengaged from the tracks 230/231, thereby enabling the user to completely remove the tabletop 110 as shown in FIGS. 2 and 3.

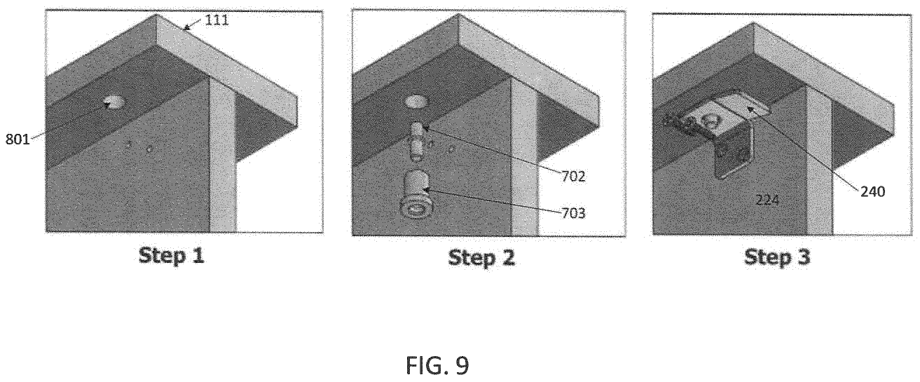

FIG. 9 illustrates step by step how to manufacture a locking mechanism according to an exemplary embodiment of the inventive concept. The locking mechanism includes the pin structure 620 and the bracket 240. In step 1 of FIG. 9, a user drills a hole into an underside of the tabletop 110 to create a recess 801. In step 2 of FIG. 9, the user inserts a metallic pin 702 into the recess 801 and covers the pin 702 with the flanged sleeve 703. The flanged sleeve 703 is inserted into the recess and fixed permanently so it cannot be moved. For example, if the diameter of the recess 801 is slightly smaller than a diameter of the flanged sleeve 703, the flanged sleeve 703 can be hammered into place. An adhesive may also be applied to the outer surface of the flanged sleeve 703 to permanently affix the flanged sleeve 703 into the recess 801. The magnetic pin 702 can move in a linear direction into the recess 702, into a first end of the flanged sleeve 703 closet to the recess 801, or partially out of a second opposing end of the flanged sleeve 702 to enter the through-hole 242 of the bracket 240. In step 3 of FIG. 8, the bracket 240 is screwed into an inner surface of side 224 of the upper portion of the base 120.

Although illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. An article of furniture comprising:
a tabletop comprising a first horizontal side, a first vertical side including a first channel, a second vertical side including a second channel and opposing the first vertical side, and a third vertical side opposing an open side, wherein the first through third vertical sides are affixed to a bottom of the first horizontal side; and
a base comprising a fourth vertical side including a first track, a fifth vertical side including a second track opposing the fourth vertical side, and a second horizontal side affixed to the fourth and fifth vertical sides to form sides of a compartment on top of the base,
wherein the channels are configured to mate with the tracks to enable the tabletop to be slid to reveal or conceal the compartment is concealed.

2. The article of furniture of claim 1, further comprising a locking mechanism located within the compartment that prevents the tabletop from being removed from the base.

3. The article of furniture of claim 1, wherein the locking mechanism comprises:
a magnetic pin affixed to the bottom of the first horizontal side and configured to move in a vertical direction; and
a bracket comprising a through-hole, the bracket affixed to a side of the compartment,
wherein the magnetic pin is configured to engage with the through-hole.

4. The article of furniture of claim 3, wherein the magnetic pin is configured to move in the vertical direction towards a top of the tabletop to disengage with the through-hole when a magnet is placed on the tabletop.

5. The article of furniture of claim 3, wherein the bracket further comprises a ramp portion that guides the magnetic pin into the through-hole.

6. The article of furniture of claim 3, wherein the through-hole is a first distance away from the vertical side the bracket is affixed to, the magnetic pin is a second distance away from one of the vertical sides of the base, and the distances are configured so that the through-hole and the magnetic pin are aligned with one another when the tabletop is mated with the base.

7. The article of furniture of claim 3, the locking mechanism further comprises a flanged sleeve disposed in a recess in the bottom of the first horizontal side, and the magnetic pin is located within a through-hole of the flanged sleeve.

8. The article of furniture of claim 7, wherein the magnetic pin comprises a cylinder and an annulus surrounding the cylinder that prevents the magnetic pin from entirely exiting an opening of the flanged sleeve.

9. The article of furniture of claim 1, wherein each channel includes a drawer slide that is configured to mate with one of the tracks.

10. The article of furniture of claim 1, wherein the base further includes a sixth vertical side and a seventh vertical side opposing the sixth vertical side to form other sides of the compartment.

11. The article of furniture of claim 10, wherein a depth of the compartment is less than a height of the sides of the base.

12. The article of furniture of claim 1, wherein the compartment has a cuboid shape.

13. The article of furniture of claim 1, the base including a removable drawer below the compartment.

14. The article of furniture of claim 1, wherein the tabletop and the base combine to form an end table.

15. An article of furniture comprising:
a tabletop comprising a movable magnetic pin affixed to a bottom surface of the tabletop and channels on sides protruding from the bottom surface;
a base comprising a first vertical side including a first track, a second vertical side including a second track opposing the first vertical side, and a horizontal side affixed to the first and second vertical sides to form sides of a compartment on top of the base; and
a bracket comprising a through-hole, the bracket affixed to a side of the compartment,
wherein the channels are configured to mate with the tracks and the magnetic pin is configured to engage with the through-hole.

16. The article of furniture of claim 15, wherein the magnetic pin is configured to move towards a top of the tabletop to disengage with the through-hole when a magnet is placed on the tabletop.

17. The article of furniture of claim 15, wherein the bracket further comprises a ramp portion that guides the magnetic pin into the through-hole.

18. The article of furniture of claim 15, wherein an end of the ramp portion is lower than the through-hole.

19. The article of furniture of claim 15, wherein the though-hole and the pin are aligned with one another when the channels are mated with the tracks.

20. The article of furniture of claim 15, further comprising a flanged sleeve disposed in a recess in the bottom of the tabletop and the magnetic pin is located within a through-hole of the flanged sleeve.
